(19) United States
(12) Patent Application Publication
(10) Pub. No.: US 2018/0046987 A1
(43) Pub. Date: Feb. 15, 2018

(54) SYSTEMS AND METHODS OF PREDICTING FIT FOR A JOB POSITION

(71) Applicant: Cangrade Inc., Cambridge, MA (US)

(72) Inventors: Gershon Goren, Newton, MA (US); Steven Lehr, Boston, MA (US)

(21) Appl. No.: 15/236,568

(22) Filed: Aug. 15, 2016

(51) Int. Cl. G06Q 10/10

(52) U.S. Cl. CPC G06Q 10/1053

(57) ABSTRACT

Disclosed are various embodiments for predicting a fit of a candidate for a job position based on past success of employees. Data can be received for employees at the company. The employees can answer survey questions to determine scales for the employees. A predictive model can be generated using the scales and the employee data. A candidate can be scored using the predictive model based on answers to survey questions provided by the candidate.

### BACKGROUND

When hiring employees for a company, Human Resource (HR) departments and hiring managers have limited interactions with candidates to determine whether or not the candidate is a good fit for the company. Companies can use software tools, such as a hiring system, to assist HR departments and hiring managers in the hiring of candidates. These hiring systems can make it easier to screen and hire candidates. A recruiter or hiring manager uses a hiring system to gather data about candidates for use in manually matching candidates who may be a good fit for one or more jobs. Candidates can also be interviewed in person ensure the candidate gets along with the employees.

However, it is difficult to predict the compatibility of a candidate with the company based on short interactions. Personality traits of a candidate may make the candidate poorly suited for the position or likely to conflict with other employees. In addition, candidates that would be extremely successful may be dismissed for employment based on a missing keyword in a resume or a filtering process that is overly simplistic. It would be desirable to predict the future success of candidates in real time when evaluating candidates for a job opportunity.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a performance analytics system according to various embodiments of the present disclosure.

FIGS. 2A-2C are pictorial diagrams of example user interfaces rendered by a client device in the performance analytics system of FIG. 1 according to various embodiments of the present disclosure.

FIG. 3 is a pictorial diagram of an example user interface rendered by a client device in the performance analytics system of FIG. 1 showing an assessment report according to various embodiments of the present disclosure.

FIG. 4 is a pictorial diagram of another example user interface rendered by a client device in the performance analytics system of FIG. 1 showing an assessment report according to various embodiments of the present disclosure.

FIG. 5 is a pictorial diagram of another example user interface rendered by a client device in the performance analytics system of FIG. 1 according to various embodiments of the present disclosure.

FIGS. 6A and 6B are pictorial diagrams of other example user interfaces rendered by a client device in the performance analytics system of FIG. 1 according to various embodiments of the present disclosure.

FIG. 7 is a pictorial diagram of another example user interface rendered by a client device in the performance analytics system of FIG. 1 according to various embodiments of the present disclosure.

FIG. 8 is a pictorial diagram of another example user interface rendered by a client device in the performance analytics system of FIG. 1 according to various embodiments of the present disclosure.

FIG. 9 is a flowchart illustrating one example of functionality implemented as portions of a modeling service, a survey service, a data service, and an assessment service executed in a computing environment in the performance analytics system of FIG. 1 according to various embodiments of the present disclosure.

FIG. 10 is a flowchart illustrating one example of functionality implemented as portions of a modeling service, a survey service, a data service, and an assessment service executed in a computing environment in the performance analytics system of FIG. 1 according to various embodiments of the present disclosure.

FIG. 11 is an example performance analytics model according to various embodiments of the present disclosure.

FIG. 12 is a schematic block diagram that provides one example illustration of a computing environment employed in the performance analytics system of FIG. 1 according to various embodiments of the present disclosure.

### DETAILED DESCRIPTION

The present disclosure relates to a performance analytics system. A performance analytics system can use predictive analytics, intuitive user interfaces, and data integrations to allow recruiters and hiring managers to hire candidates more quickly and with greater confidence that the candidate will be a good fit for a particular job.

Generally, the performance analytics system can evaluate candidates based on a variety of inputs. One of the inputs can be employee answers to survey questions. As such, candidate answers to survey questions can be evaluated based on answers from employees to survey questions, and performance and work histories for those employees, among other inputs. Accordingly, the performance analytics system can generate a list of candidates, and identify a best fit between a candidate and a job position. A “best fit” can be determined, for example, by a prediction based on the performance analytics system performing a regression analysis on various quantitative inputs. The term “best fit” can refer to a candidate having a highest predicted score, a job position with which the candidate scores the highest predicted score, or other evaluation of a candidate's fit for a job position.

More specifically, the performance analytics system can include services, which can process and organize employee answers to survey questions, in combination with performance data, to create scales and/or generate weights for pre-existing scales. The performance analytics system can also analyze the inputs and scales to generate a predictive model.

A survey service can present survey questions to a candidate for a job position. The survey questions can be selected based on a variety of factors. In one example, survey questions for a candidate are based on what scales correlate to performance for a job position. A modeling service can calculate scores based on a predictive model and candidate answers to survey questions. Finally, an assessment service can calculate a score of a fit of a job candidate. Accordingly, the assessment service can provide a list of job candidates ranked by score.

It is understood that an employee can be a job candidate for a job position. Additionally, a job candidate can be an employee of a company. Further, the terms candidate and/or employee can be used to refer to a previous employee, a current employee, a perspective employee, or any other person. Further, when specifying either a candidate or an employee herein, the same functionality can be performed with respect to an employee or a candidate, respectively. As such, the usage of the terms candidate and employee are not meant to be limiting.

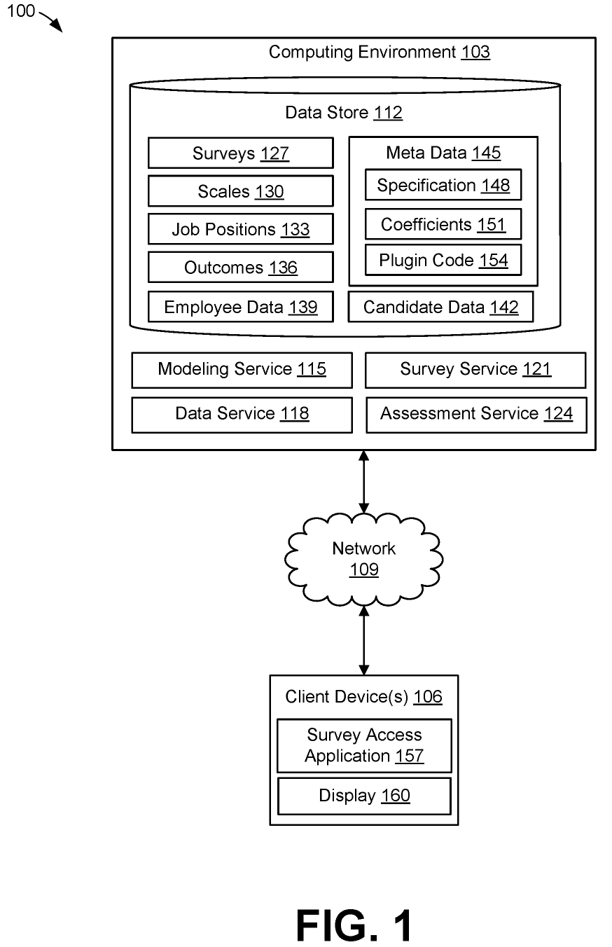

With reference to FIG. 1, shown is a performance analytics system 100 according to various embodiments. The performance analytics system 100 includes a computing environment 103 and one or more client device 106, which are in data communication with each other via a network 109. Various applications and/or functionality may be executed in the computing environment 103 according to various embodiments. The applications executed on the computing environment 103 include a modeling service 115, a data service 118, a survey service 121, an assessment service 124, and other applications, services, processes, systems, engines, or functionality not discussed in detail herein. Also, various data can be stored in a data store 112 that is accessible to the computing environment 103. The data store 112 may be representative of multiple data stores 112 as can be appreciated.

The data store 112 can store industry data, company data, organization data, employee data, job position or role data, job openings, model, coefficient, and other analytics data, as can be fully appreciated based on the disclosure contained herein. The data stored in the data store 112 includes, for example, surveys 127, scales 130, job positions 133, outcomes 136, employee data 139, candidate data 142, and potentially other data. The scales 130 can include a value evaluating a skill, trait, attribute, competency, attribute of a job position 133, attribute of a company, or other aspect of a user. Several example scales 130 include “Quantitative,” “Creative,” “Social,” “Organized,” “Stressful,” “Self Starting,” “Broad Thinking,” “Trust,” “Confidence,” “Precision,” Organization,” and other scales.

Additionally, the data store 112 can include meta data 145, which can be generated by the modeling service 115, manually entered by an administrator, or modified by the administrator. The meta data 145 can includes a specification 148, coefficients 151, and plugin code 154. The data stored in the data store 112, for example, is associated with the operation of the various applications and/or functional entities described below.

The one or more client devices 106 can be configured to execute various applications such as a survey access application 157 and/or other applications. The survey access application 157 can be executed in a client device 106, for example, to access network content served up by the computing environment 103 and/or other servers, thereby rendering a user interface on the display 160. To this end, the survey access application 157 can be a browser, a smart phone app, a dedicated application, or another application. The user interface can include a network page, an application screen, or another interface. The client device 106 can be configured to execute applications beyond the survey access application 157 such as, for example, email applications, social networking applications, word processors, spreadsheets, and/or other applications.

The client device 106 can include a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, or other devices with like capability. The client device 106 may include a display 160. The display 160 may comprise, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The network 109 can include, for example, the internet, intranets, extranets, wide area networks (WANs), local area networks (LANs), wired networks, wireless networks, or other suitable networks, etc., or any combination of two or more such networks. For example, such networks may comprise satellite networks, cable networks, Ethernet networks, and other types of networks.

Regarding operation of the various components of the performance analytics system 100, the survey service 121 can present a survey 127 to a client device 106. The survey 127 can include survey questions, answers to survey questions (survey answers), categorical information corresponding to each survey question, and other survey related information. The categorical information can include a scale 130 that each survey question is intended to evaluate. The survey questions can be selected from a survey 127 using the survey service 121. The surveys 127 can include survey questions and answers to survey questions (survey answers).

Additionally, a data service 118 can be used to correlate and populate other data stored in the data store 112. The data service 118 can provide import, export, and data management services. Another aspect of the data service 118 is the ability to gather performance data, such as, for example, metrics representing the performance of an employee in a given job position or role. As one example, the data service 118 can receive data describing employees. The data describing the employees can be mapped to the employee data 139.

The data service 118 can store data describing the employee in the employee data 139. Specifically, data management services of the data service 118 can access employee data fields stored outside the computing environment 103, such as organization name, organizational units, employee lists, employee groups, employee names, job codes, job titles, salaries, start dates, lengths of employment, performance reviews, and other relevant data. The performance data for employees can be used to determine a job performance metric or a job success metric. The job performance metric can be a weighed value based on performance reviews of the employee. The job success metric can be based on the performance reviews and various other factors, such as, for example, a personality profile of the employee, length of employment, organizational information, and other data.

The survey service 121 can present a survey 127 to a user of a client device 106. The survey 127 can include survey questions corresponding to one or more scales 130 that relate to the user. For example, some of the survey questions can correspond to a “Job Engagement” scale 130 for the user. In one embodiment, the survey service 121 can select survey questions that correspond only to specific scales 130. As an example, the survey service can limit the number of scales 130 that survey questions are selected from for a candidate based on the meta data 145 for a job position 133. In this example, the number of questions in a survey 127 can be reduced by only evaluating scales 130 with the greatest impact on the outcome 136.

The survey service 121 can present a series of questions from the survey 127. The series of questions can be provided through a single page web application. The survey service 121 can receive answers to each of the series of questions to gather a survey result. The survey service 121 can provide a score for a candidate instantaneously upon receiving answers to the survey questions. As an example, upon completing a survey 127, the survey service 121 can use the meta data 145 to generate an outcome 136 for the candidate without further user interaction required. The survey service 121 can present the time elapsed and a progress of the survey 127 or a task within the survey 127. In one example, the survey service 121 gathers survey results from some or all employees at a company.

The survey service 121 can facilitate the creation of survey 127. Different surveys 127 can be created for different job positions 133. The survey service 121 can select survey questions from a bank of questions within surveys 127. The selection can be based on various factors, such as, for example, a score of how important each scale 130 is for a job position 133. In one example, the company can select competencies from a pool, and the survey service 121 can select survey questions based on the company selections. The assessment service 124 can benchmark and evaluate the predicted outcomes 136 to determine a success rate of the assessments, such as, for example, the success of a predictive model that is based on the company selections. The importance of each scale 130 can be determined based on the meta data 145. The survey service 121 can receive a selection of survey questions from the bank of questions through an administrative user interface. By creating a survey 127 for a particular job position 133, one or more scale 130 can be used to determine a success profile for the job by which potential candidates can be evaluated. The success profile can be based on personality traits, motivators, soft skills, hard skills, attributes, and other factors or scales 130.

According to one example, the survey service 121 selects survey questions corresponding to a “Preference for Quantification” scale 130 from the bank of questions within surveys 127. The selection of the “Preference for Quantification” scale 130 can be selected for surveys 127 to evaluate candidates. The selection of the “Preference for Quantification” scale 130 can occur in response to determining a correlation between the “Preference for Quantification” scale 130 and performance in a job position 133, such as, for example, when generating the meta data 145. The assessment service 124 can use answers to the selected survey questions to evaluate the “Preference for Quantification” scale 130 for a user. The modeling service 115 can use the scale 130 for the user to evaluate an importance of the “Preference for Quantification” scale 130 for a job position 133.

In one embodiment, the survey service 121 can generate user interfaces to facilitate the survey 127 of a user of a client device 106. As an example, the survey service 121 can generate a web page for rendering by the survey access application 157 on the client device 106. In another example, the survey service 121 can send the survey questions to the survey access application 157, and the survey access application 157 can present the questions on the display 160.

The modeling service 115 can generate a predictive model based on various data. The modeling service 115 can store data describing the model within meta data 145. The modeling service 115 can calculate the predictive model by analyzing the employee data 139 and scales 130. As such, the modeling service 115 can provide a step-wise modeling feature, a reduced step-wise modeling feature, a linear modeling feature, and other modeling features. Accordingly, the modeling service 115 can create a predictive model that can be used by the computing environment 103 to generate predictions of likely outcomes 136 for candidates. By creating a predictive model that can be used to grade candidates, a validated fit between a candidate and a job position can be determined based on a success profile for the candidate.

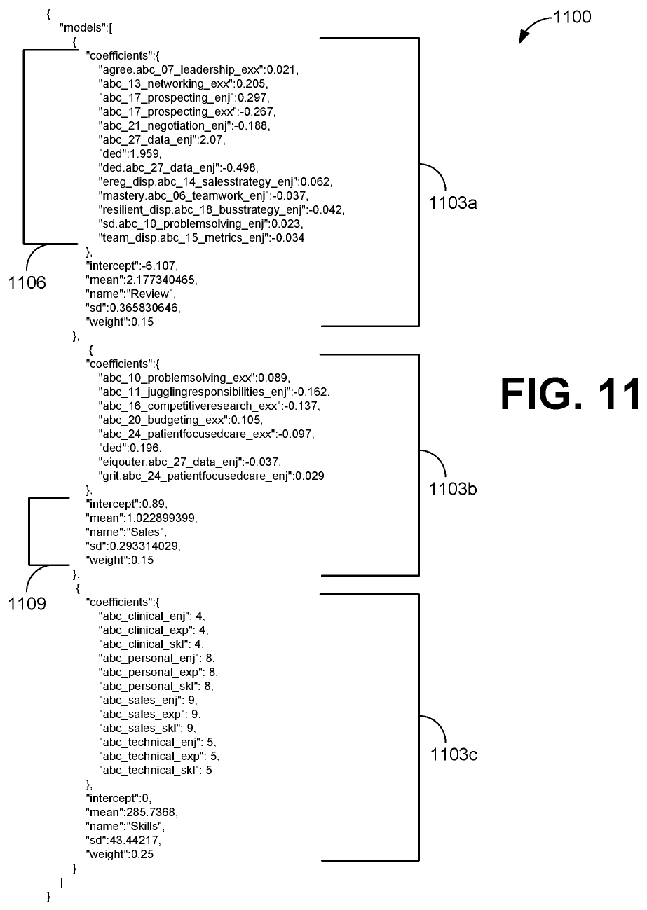

The modeling service 115 can create the meta data 145. As an example, meta data 145 can include specification 148, coefficients 151, and plugin code 154. A specification 148 includes the data elements that define a predictive model, including various constants and relevant relationships observed between data elements. The modeling service 115 can create the specification 148 including a model definition, such as, for example, performance analytics model 1100 in FIG. 11. The model definition can be in any suitable format (e.g., a JSON format, other open-source XML format, or other proprietary format).

The coefficients 151 can be defined by a name and value pair. The coefficients 151 can individually correspond to a particular scale 130. As a non-limiting example, a coefficients 151 for scales 130 related to a particular “Sales” job position 133 can have a name series of “Leadership,” “Networking,” “Prospecting,” “Negotiation,” “Dedication,” “Sales Strategy,” “Teamwork,” “Business Strategy,” “Problem Solving,” and “Discipline.” In another example, a coefficients 151 for scales 130 related to a particular healthcare job position 133 can have a name series of “Simplifying Complexity,” “Business Strategy,” “Physician Communication,” “Patient Focused Care,” “Computers,” “Multitasking,” “Competitive Research,” and “Medical Products,” or other names. Each name of a coefficient 151 can have an associated value containing a real, rational number.

Another operation of the computing environment 103 is to calculate a predicted outcome 136 for a candidate applying for a job position 133. An outcome 136 can relate to the result of the assessment service 124 applying a predictive model to a candidate. For example, the assessment service 124 can apply a predictive model to the answers to the survey questions provided by the candidate to generate an outcome 136 for the candidate. In another example, the outcome 136 for a job position 133 can be determined without the candidate applying for the job position 133. In one embodiment, the candidate can be an employee within the organization. For example, answers to survey questions from employees can be used to evaluate the employees for a job position 133 after the modeling service 115 generates the meta data 145 corresponding to that job position 133. Thus one operation of the computing environment 103 can be to calculate multiple predictive outcomes 136, based on a predictive model, for an employee within the organization for multiple job positions 133.

The plugin code 154 is executed by the computing environment 103 to provide certain customization features for standard and non-standard employee job positions 133. The plugin code 154 can be input by a user or generated by the modeling service 115. For example, certain industries have special job positions 133 that require a customized candidate grading system. The plugin code 154 can execute custom logic when evaluating a candidate. The plugin code 154 can be executed by the assessment service 124 to modify or extend the predictive model.

The assessment service 124 can generate a score predicting a fit for a candidate in a job position 133 and store the score as an outcome 136. The assessment service 124 can also score candidates based on a number of different inputs including meta data 145. The assessment service 124 can score candidates based on a candidate's answers to survey question, in combination with a predictive model previously described, according to a specification 148 and coefficients 151. As an example, the assessment service 124 or the survey service 121 can score the candidate on one or more scales 130 based on the candidate's answers to the survey questions.

The assessment service 124 can determine an outcome 136 predicting a fit of the candidate in the job position 133 based on multiply coefficients 151 by the respective scale scores calculated from the answer from the candidate. The assessment service 124 can determine and provide outcomes 136 for one or more candidates. The assessment service 124 can generate a user interface with a ranked list of job candidates ranked by scores.

In one embodiment, the client device 106 runs a survey access application 157 to provide a mechanism for an employee or candidate to read survey questions from a display 160. Thus, an employee or candidate can use the survey access application 157 to answer survey questions selected by the survey service 121. The questions answered by the employee or candidate using the survey access application 157 can be from a survey 127. The survey answers can be evaluated based on the meta data 145 including the specifications 148 and the coefficients 151. For example, a candidate can answer questions related to a multiple scales 130 including Patient Focused Care. Thus, an outcome 136 for the candidate performance can be determined using the meta data 145.

A data service 118 can receive employee data 139 describing an employee at a company. A survey service 121 can receive answers to survey questions from the employee using the survey access application 157. A survey service 121 can calculate scales 130 for the employee based on the answers to survey questions. In one example, the scales 130 can also be based on the employee data 139. The modeling service 115 can generate meta data 145 for a performance analytics model based on the scales 130 and employee data 139. The survey service 121 can receive candidate data 142 including candidate answers to survey questions from a job candidate. The assessment service 124 can calculate scale scores for the job candidate based on the candidate answers. Finally, an assessment service 124 can predict an outcome 136 of a fit of the job candidate based on the scale scores for the candidate and the performance analytics model.

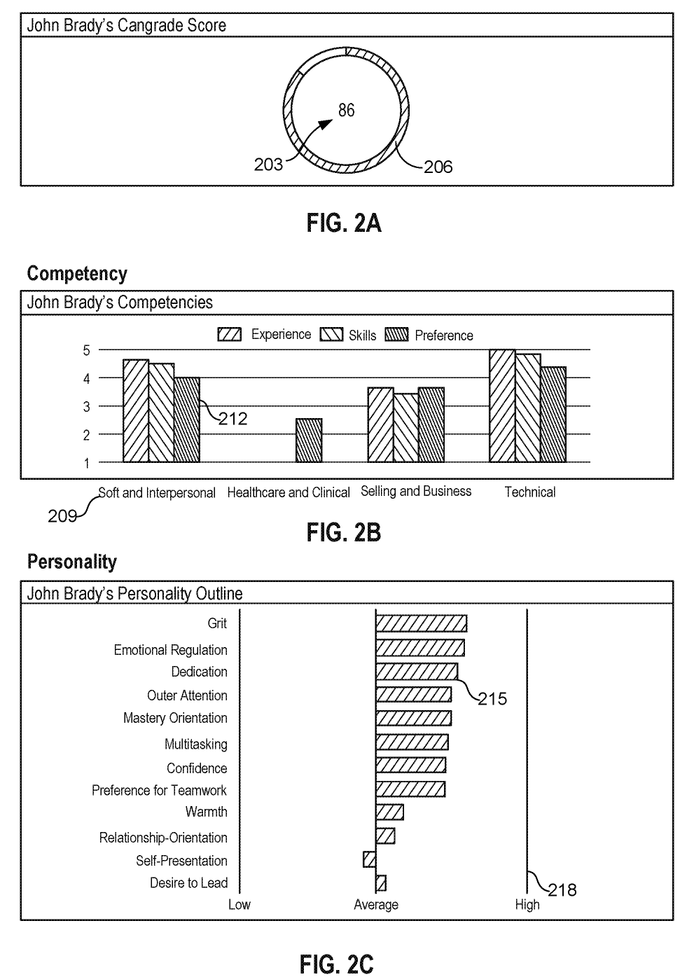

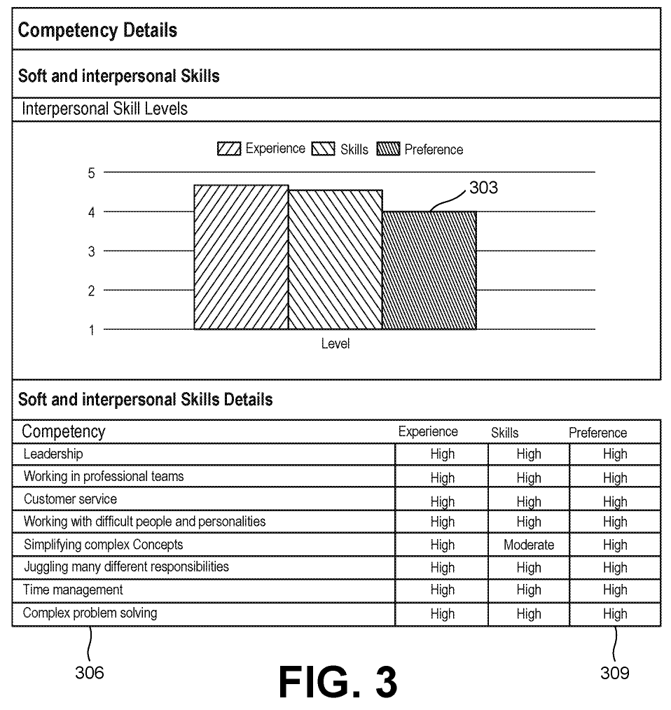

Turning now to FIGS. 2A-2C, shown are examples of user interfaces depicting a score for a candidate, such as an outcome 136. With reference first to FIG. 2A, shown is a user interface diagram depicting an example of a portion of an assessment report generated by assessment service 124 rendered on display 160. The assessment report can include a textual element 203 representing a score for a given candidate, as well as a graphical element 206 corresponding to the score. In the embodiment, the textual element displays a raw score, and the graphical element 206 displays a radial chart. In another embodiment, the textual element could be an average score, a standard deviation, or some other score. Additionally, the graphical element could be a pie chart, bar chart, histogram, or some other graphical representation.

With reference to FIG. 2B, shown is a user interface depicting a portion of an assessment report, this time showing a bar chart of candidate performance for several scales 130, with performance grouped by competency type 209 (e.g., Soft and Interpersonal). Each competency can be further broken down by the categories of Experience, Skills, and Preference, or other categories. The bar indicator 212 can represent a scale 130 of a candidate for a Preference category of the Soft and Interpersonal competency type 209, and can accordingly be used to effectively score or screen a particular candidate for a job position 133.

Finally, FIG. 2C shows a user interface depicting yet another portion of an assessment report including a personality outline screen of an assessment report, broken down by a given personality attributes of a candidate. In this embodiment, personality attributes are shown on a scale between low, average, and high. The personality attribute 215 represents a score for a “Dedication” personality attribute. In this embodiment, the personality attribute 215 can be compared to an average score, an ideal score, or some other score. The vertical indicator 218 (e.g., High) can represent a candidate's score compared to a standard deviation for that personality attribute.

Referring next to FIG. 3, shown is another user interface diagram depicting an example of a portion of an assessment report generated by assessment service 124 rendered on a display 160. In a first section of the user interface (e.g., Interpersonal Skill Levels), skill levels are plotted in a bar chart. Skill Details are presented in a section of the user interface in a list by Competency Name, along with a score for each of an Experience, a Skills, and a Preference, where the score shown may range from “Low,” “Moderate,” and “High.” In this example, a bar indicator 303 represents a score for a candidate grouped by interpersonal skills according to candidate preference, on a level from one to five.

The bar indicator 303 can represent a five-point range (e.g., Likert range), some other range, or some other representation of a score. In another example, each skill can be grouped by a competency. The example of FIG. 3 shows a competency of “Complex problem solving” with candidate performance detailed across “Experience,” “Skills,” and “Preference.” Here, a preference indicator 309 indicates a candidate preference for complex problem solving is high, which can indicate a good fit between a candidate and a job position 133 that includes complex problem solving. As an example, an outcome 136 can be higher for a first candidate that has a high complex problem solving in contrast to a second candidate with a low complex problem solving when a complex problem solving scale 130 correlates to performance for a job position 133.

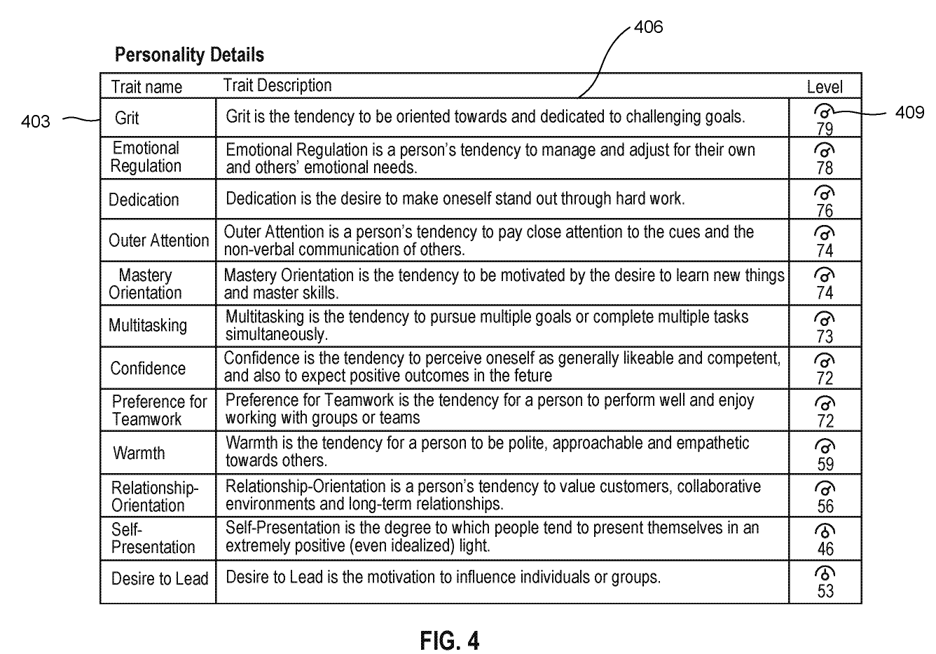

Referring next to FIG. 4, shown is another user interface diagram depicting an example of a portion of an assessment report generated by assessment service 124. In this embodiment, a personality details report shows a table of trait names, trait descriptions, and level for a particular candidate. Thus, a name 403 for a scale 130 (e.g., Grit) can be presented near a textual value indicating the candidate's score for that scale 130 (e.g., 79). A description 406 can also be provided to help explain the given scale 130. A visual indicator 409 for a scale score can be presented corresponding with the textual value for the scale score, using a temperature gauge, a radial chart, a bar chart, or some other graphical representation of a score.

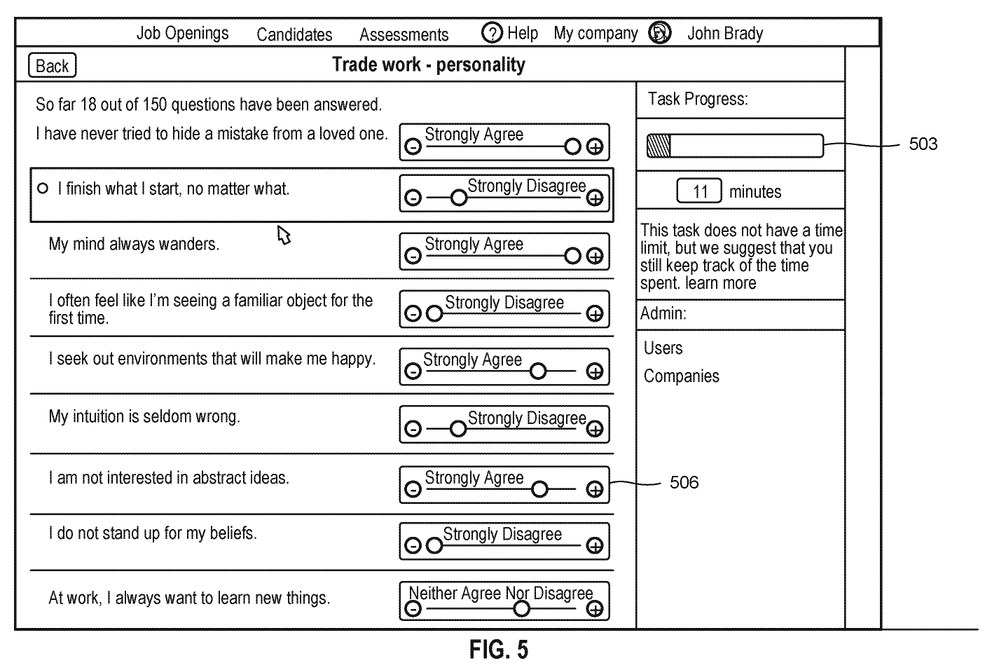

Referring next to FIG. 5, shown is a user interface diagram depicting an example of a survey generated by a survey service 121 accessed by a survey access application 157 and rendered on display 160. Here, a candidate or an employee (a “client”) has accessed a survey using client device 106. In this embodiment, a task progress indicator 503 shows the progress of the client through the survey. The task progress indicator 503 could indicate progress based on progress through a static number of pages, or alternatively, the task progress indicator 503 could indicate progress based on answers to survey questions (e.g., an adaptive test). Survey questions (e.g., 150 questions) have been prepared for the client. The client can tap, press, or otherwise manipulate the user interface to answer the questions presented. Client answers to survey questions are collected through survey access application 157 and can be stored as employee data 139, candidate data 142, or both. The example interface shown in FIG. 5 allows the client to answer survey questions using a five-point responsive range 506 (e.g., Likert range), although the responsive range could also be a three-point range, a seven-point range, other range, or other input methods (e.g., text fields). A client can use the interface to navigate through a survey (e.g., using a back button to go to a previous page listing survey questions). Accordingly, the interface shown in FIG. 3 allows a client to start a survey, select survey questions, provide answers to survey questions, navigate, and track progress. Additionally, the interface shown can also be used to collect responses from candidates or other people.

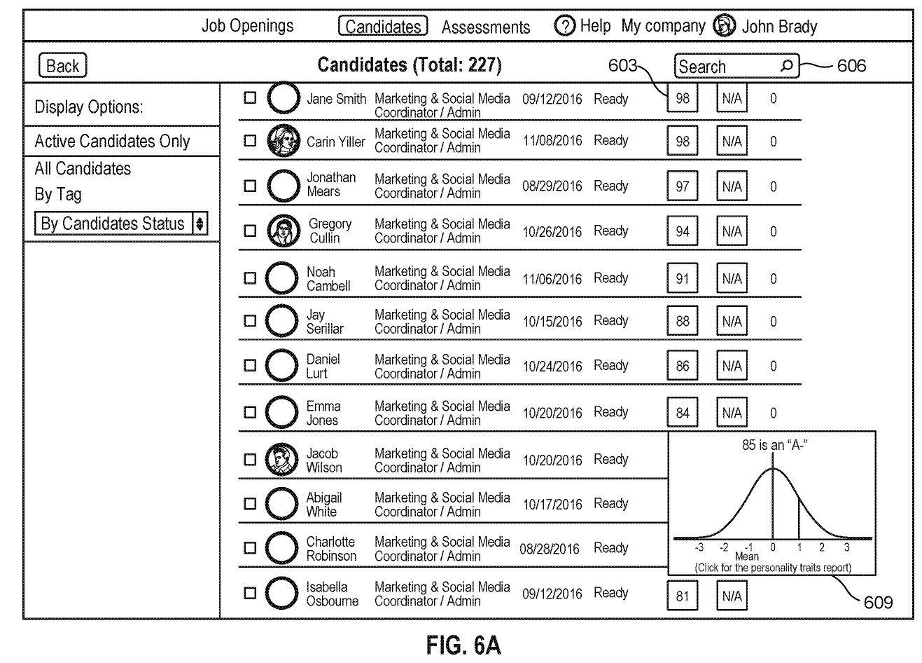

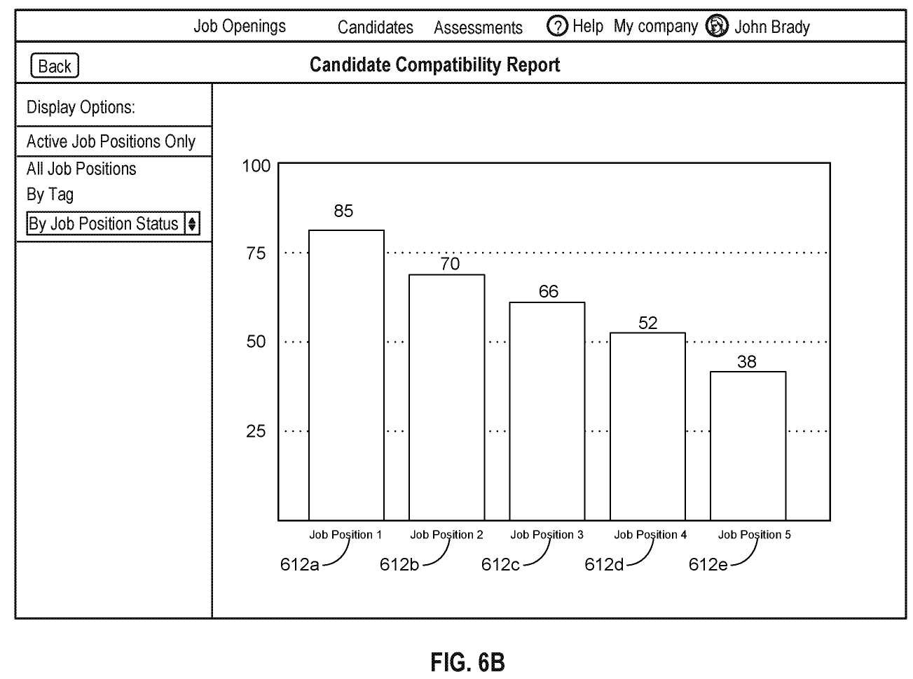

Referring to FIG. 6A, shown is a user interface diagram depicting an example of an assessment report generated by assessment service 124 rendered on display 160 according to FIG. 1. In this embodiment, a hiring manager or other administrator has performed a search for candidates and the performance analytics system has returned a list of candidates. The list of candidates is presented in a table that includes data elements relating to that particular candidate (e.g., candidate name, candidate title, date, candidate status) along with a candidate grade. The candidate grade in this embodiment presents as a textual element 603, but in other embodiments it can present as a graphical element (e.g., a graph detailing statistical properties of scores of fit of candidates for jobs), or in other ways as can be readily understood. Additionally, a search box 606 allows searching on many data elements and is not limited to those data elements enumerated above. The user interface diagram can include a 609 graph detailing statistical properties for the candidates. As shown, the assessment report can be sorted by candidate status, but it could be sorted by other data elements. Accordingly, a hiring manager can use the example user interface of FIG. 6A to create a list of candidates who may be a good fit for a job.

With reference to FIG. 6B, shown is a user interface diagram depicting an example of a candidate compatibility report generated by assessment service 124 rendered on display 160 according to FIG. 1. In this embodiment, a hiring manager or other administrator can view a list of potential job positions 612a-e for a single candidate or employee. The outcomes 136 for multiple job positions 133 can be determined without the candidate applying for each of the job positions 133. As an example, a hiring manager can select to evaluate a candidate for multiple job positions 133. The assessment service 124 can generate a predicted outcome 136 for each of the job positions 133 for the candidate.

The list of potential job positions 133 can be presented in a graph that includes a candidate grade of the candidate, such as an outcome 136, for each of the job positions 612a-e. In one embodiment, the assessment service 124 can automatically score all employees and candidates for all job positions 133. As an example, the assessment service 124 can score all employees and candidates for all job positions 133 without receiving a request from a hiring manager to evaluate a candidate. Accordingly, a hiring manager can use the example user interface of FIG. 6B to view a compatibility report for a candidate in view of multiple job positions 133.

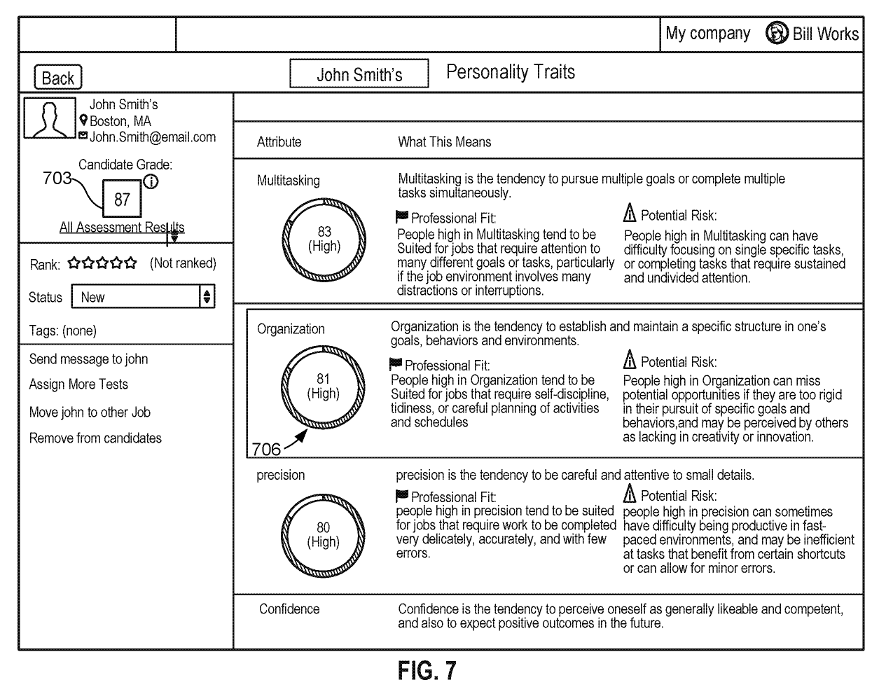

Referring next to FIG. 7, shown is a user interface diagram depicting an example of a portion of an assessment report generated by assessment service 124 rendered on display 160. This example report depicts, among other things, a way to view a particular candidate's overall grade 703 together with his or her individual grades broken down by scale 130. The user interface for an “Organization” attribute 706 can display a textual element and a graphical element representing the score of a candidate relating to organizational skills. Here, the user interface has presented information (e.g., a description for scale score types) about the organizational skills to describe the professional fit and potential risks characteristics of the organizational skill. In this embodiment, a hiring manager or other administrator can send a message to the candidate, assign the candidate more tests, rank the candidate, assign tags to the candidate, or perform various other features as disclosed herein.

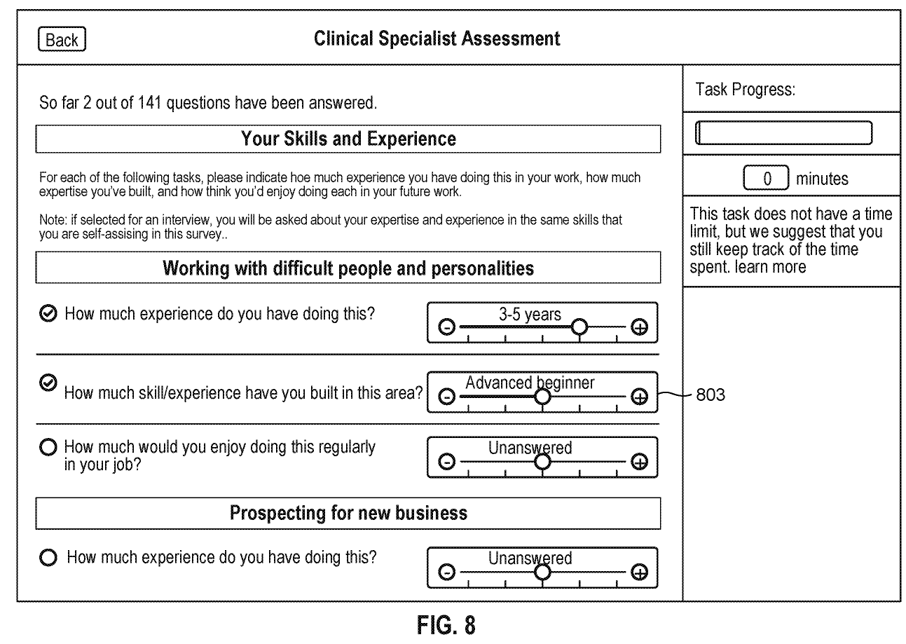

With reference next to FIG. 8, shown is a user interface diagram depicting an example of a survey generated by a survey service 121 accessed by a survey access application 157 and rendered on display 160. Here, an employee has accessed a survey 127 using a client device 106. Survey questions (e.g., 150 questions) have been prepared for the employee to help assess the employee's fit for either the employee's current position, a different position, or both.

The example interface shown in FIG. 8 allows an employee to answer survey questions using a five-point responsive range 803 (e.g., Likert range), although the responsive range could also be a three-point range, a seven-point range, other range, or other input methods (e.g., text fields). An employee can use the interface to navigate through a survey 127 (e.g., using a back button to go to a previous page listing survey questions). Accordingly, the interface shown in FIG. 8 facilitates an employee to starting a survey 127, providing answers to survey questions, navigating a survey 127, and tracking progress through the survey 127. The answers to survey questions can be stored by survey access application 157.

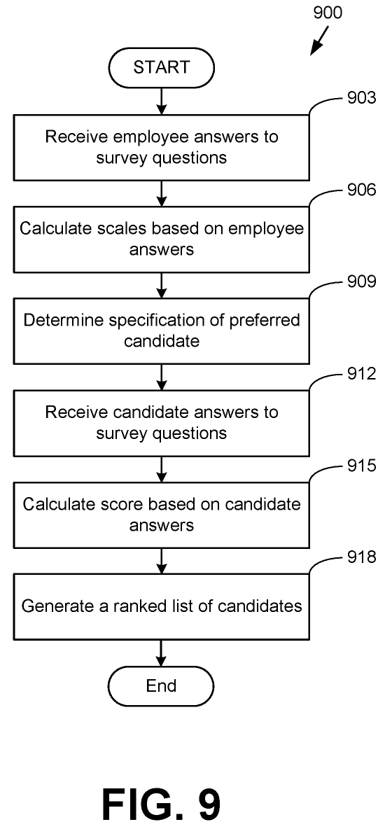

Referring next to FIG. 9, shown is a flowchart that provides one example of the operation of a portion of the performance analytics system 100 according to various embodiments. It is understood that the flowchart of FIG. 9 provides merely an example of the many different types of functional arrangements that may be employed to implement the operation of the portion of the performance analytics system 100 as described herein. As an alternative, the flowchart of FIG. 9 may be viewed as depicting an example of elements of a method implemented in the computing environment 103 (FIG. 1) according to one or more embodiments.

Beginning with box 903, the computing environment 103 receives employee answers to survey questions. As described above, the employee may answer survey questions using a survey access application 157. Employee answers may be gathered using a five-point responsive range (e.g., Likert range), three-point range, seven-point range, or another input method.

At box 906, a modeling service 115 or survey service 121 calculates scales 130 based on employee answers. The scale 130 can be based on a number of questions answered affirmatively that correspond to the scale 130.

At box 909, the modeling service 115 creates a predictive model that includes the specification 148 of a preferred candidate. The modeling service 115 can generate a predictive model including meta data 145. The predictive model can be based, among other things, on employee data 139 and scales 130. The meta data 145 of the preferred candidate, or the specification 148, can include a model definition in any suitable format (e.g., a JSON format, other open-source XML format, or other proprietary format).

At box 912, the survey service 121 receives candidate answers to survey questions. The candidate can answer survey questions using a survey access application 157. Candidate answers can be gathered using a five-point responsive range (e.g., Likert range), three-point range, seven-point range, or other input method. In some embodiments, a candidate can save a survey 127 and later resume the survey 127 using the survey service 121.

At box 915, the assessment service 124 calculates a score based on candidate answers to survey questions. For example, the assessment service 124 can calculate an outcome 136. The calculation of the score can be performed in a number of different ways. The score can be based on a comparison of candidate answers to with a specification 148. In one example, a number of employees within a given organization provided answers to survey questions, which are used to generate the specification 148. Thus, a score can be based on a comparison of scales 130 for a candidate to scales 130 of one or more employees. Additionally, in another embodiment, a score can be based on objective criteria such as a comparison of candidate answers to correct answers. This embodiment can be useful for determining a candidate's proficiency in a particular knowledge area.

At box 918, the assessment service 124 generates a ranked list of candidates. The results from one or more candidates taking a survey can be stored as candidate data 142 in the data store 112. A hiring manager or some other person can navigate a user interface (see, e.g., FIG. 6) to display a ranked list of candidates on a client device 106. One objective of displaying a ranked list of candidates is to identify a candidate who is a best fit for a job position 133. Thus, the ranked list can display, from among all the candidates with candidate data 142 in the data store 112, only those candidates who meet certain criteria. In this way, the number of potential candidates can be reduced by only evaluating the candidates who are the best fit with a job. The candidates can also be filtered based on which candidates are currently seeking employment and other factors configured to the needs and requirements of the end user.

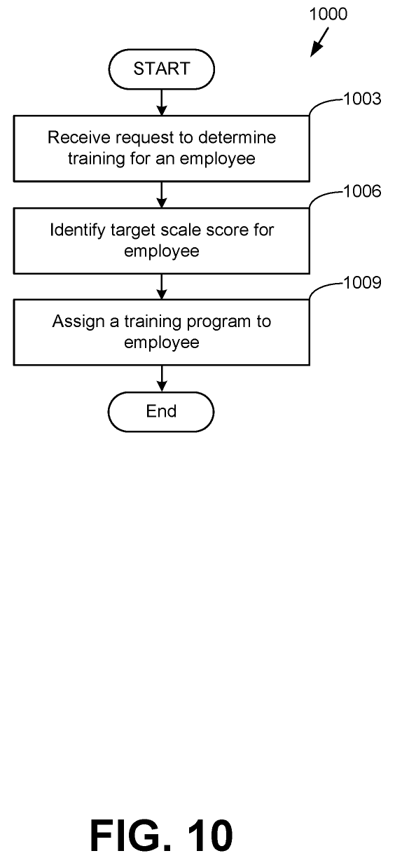

Referring next to FIG. 10, shown is a flowchart that provides another example of the operation of a portion of the performance analytics system 100 according to various embodiments. It is understood that the flowchart of FIG. 10 provides merely an example of the many different types of functional arrangements that may be employed to implement the operation of the portion of the performance analytics system 100 as described herein. As an alternative, the flowchart of FIG. 10 may be viewed as depicting an example of elements of a method implemented in the computing environment 103 (FIG. 1) according to one or more embodiments.

In one embodiment of the system, the performance analytics system 100 is used to assign training for an employee. At box 1003, the assessment service 124 can receive a request to determine training for an employee. In one example, a trainer submits a request to find a threshold quantity of employees required to offer a specific training program that corresponds to improving one or more scale 130. In another embodiment, a user can submit a request to determine what training materials to offer employees. In yet another embodiment, an employee can request a ranked list of training programs that would provide the biggest improvement to an outcome 136 of the employee for a current or potential job position 133 of the employee.

At box 1006, the assessment service 124 identifies a target scale score for training for an employee. According to some examples, the assessment service 124 iterates through each scale 130 for the employee and calculates a theoretical outcome 136 for the employee if the scale 130 from the current iteration were greater by a predefined amount. Then, the assessment service 124 identifies the scale 130 that improved the outcome 136 by a greatest amount as the target scale score. The iterations can be limited to scales 130 corresponding to training courses currently offered. Further, the predefined amount from the calculation of the theoretical outcome 136 can be different for each scale 130, such as, for example, based on a projected improvement to the scale 130 from a training course. In another example, the assessment service 124 identifies the target scale score as the scale 130 that corresponds to a greatest coefficient 151.

A survey 127 can be given to participants in training programs before and after to evaluate the improvement of the participant on given scales. When determining a target scale score for training, the predefined amount added to a scale 130 of the employee can be based on the improvement of past participants. As an example, the employee may be projected to improve “Confidence” by 12 points by taking a training program entitled “Lead with Confidence,” but only improve “Multitasking” by 2 points by taking “Secrets to Multitasking,” where the projections are based on the past improvements of participants taking the training programs. However, in one example, the target scale score can still be “Multitasking” scale 130 if adding 2 points improves the outcome 136 by a greater amount than adding 12 to the “Confidence” scale 130.

At box 1009, the assessment service 124 assigns a training program to an employee. The assessment service 124 can assign a training program corresponding to the target scale score to the employee. In one embodiment, the assessment service 124 can assign training to a threshold quantity of employees for a training program. In another embodiment, the assessment service 124 can schedule training programs for a company based on which target scale scores are identified for employees within the company.

Turning to FIG. 11, shown is a performance analytics model 1100 according to various embodiments of the present disclosure. The performance analytics model 1100 includes subcomponents 1103a, 1103b, and 1103c. Each of the subcomponents can include a coefficients section 1106 and a statistical data section 1109. The coefficients section 1106 can include one or more coefficients 151, each of which can include a name value pair. The coefficients 151 contained in a given coefficients section 1106 can be based on whether a correlation, partial correlation or other statistical relationship exists between a scale 130 and performance data in employee data 139. As a non-limiting example, if a scale 130 that corresponds to years of experience strongly correlates as a dependent variable on predicting an independent variable of skill for a job position 133, then a “abc_personal_exp” coefficient 151 can be included with a value of 8 in a coefficients section 1106 that is used to predict skill for the job position 133, as shown in subcomponent 1103c.

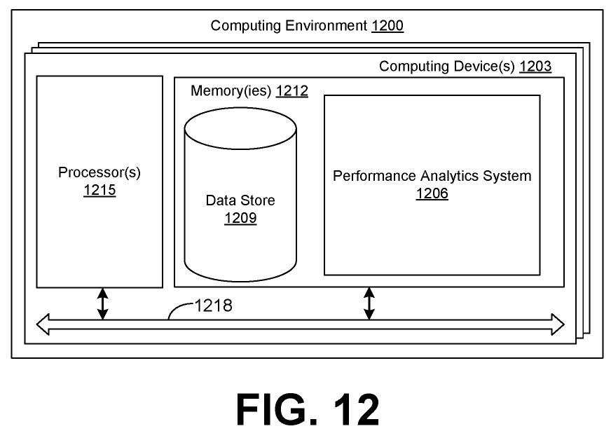

Moving on to FIG. 12, shown is a schematic block diagram of the computing environment 103 according to an embodiment of the present disclosure. The computing environment 103 includes one or more computing devices 1203. Each computing device 1203 includes at least one processor circuit, for example, having a processor 1215 and a memory 1212, both of which are coupled to a local interface 1218. To this end, each computing device 1203 may comprise, for example, at least one server computer or like device. The local interface 1218 may comprise, for example, a data bus with an accompanying address/control bus or other bus structure as can be appreciated.

Stored in the memory 1212 are both data and several components that are executable by the processor 1215. In particular, stored in the memory 1212 and executable by the processor 1215 are list of main applications, and potentially other applications. Also stored in the memory 1212 may be a data store 112 and other data. In addition, an operating system may be stored in the memory 1212 and executable by the processor 1215.

It is understood that there may be other applications that are stored in the memory 1212 and are executable by the processor 1215 as can be appreciated. Where any component discussed herein is implemented in the form of software, any one of a number of programming languages may be employed such as, for example, AJAX, C, C++, C#, Objective C, Java®, JavaScript®, Perl, PHP, Visual Basic®, Python®, Ruby, Flash®, or other programming languages.

A number of software components are stored in the memory 1212 and are executable by the processor 1215. In this respect, the term “executable” means a program file that is in a form that can ultimately be run by the processor 1215. Examples of executable programs may be, for example, a compiled program that can be translated into machine code in a format that can be loaded into a random access portion of the memory 1212 and run by the processor 1215, source code that may be expressed in proper format such as object code that is capable of being loaded into a random access portion of the memory 1212 and executed by the processor 1215, or source code that may be interpreted by another executable program to generate instructions in a random access portion of the memory 1212 to be executed by the processor 1215, etc. An executable program may be stored in any portion or component of the memory 1212 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 1212 is defined herein as including both volatile and nonvolatile memory and data storage components. Volatile components are those that do not retain data values upon loss of power. Nonvolatile components are those that retain data upon a loss of power. Thus, the memory 1212 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 1215 may represent multiple processors 1215 and/or multiple processor cores and the memory 1212 may represent multiple memories 1212 that operate in parallel processing circuits, respectively. In such a case, the local interface 1218 may be an appropriate network that facilitates communication between any two of the multiple processors 1215, between any processor 1215 and any of the memories 1212, or between any two of the memories 1212, etc. The local interface 1218 may comprise additional systems designed to coordinate this communication, including, for example, performing load balancing. The processor 1215 may be of electrical or of some other available construction.

Although the performance analytics system 100, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 9 and 10 show the functionality and operation of an implementation of portions of the application. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 1215 in a computer system or other system. The machine code may be converted from the source code, etc. If embodied in hardware, each block may represent a circuit or a number of interconnected circuits to implement the specified logical function(s).

Although the flowcharts of FIGS. 9 and 10 show a specific order of execution, it is understood that the order of execution may differ from that which is depicted. For example, the order of execution of two or more blocks may be scrambled relative to the order shown. Also, two or more blocks shown in succession in FIGS. 9 and 10 may be executed concurrently or with partial concurrence. Further, in some embodiments, one or more of the blocks shown in FIGS. 9 and 10 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including a performance analytics system 100, that comprises software or code can be embodied in any non-transitory computer-readable medium for use by or in connection with an instruction execution system such as, for example, a processor 1215 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including list of main applications, may be implemented and structured in a variety of ways. For example, one or more applications described may be implemented as modules or components of a single application. Further, one or more applications described herein may be executed in shared or separate computing devices or a combination thereof. For example, the applications described herein may execute in the same computing device 1203, or in multiple computing devices in the same computing environment 1200. Additionally, it is understood that terms such as “application,” “service,” “system,” “engine,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A non-transitory computer-readable medium embodying a program that, when executed by at least one computing device, causes the at least one computing device to at least:
receive data describing an employee at a company;
receive a plurality of employee answers to a subset of a plurality of candidate questions from the employee;
calculate a plurality of scale scores for the employee based at least in part on the plurality of employee answers, the plurality of scale scores individually corresponding to a plurality of attribute types;
generate a performance analytics model based at least in part on the plurality of scale scores and the data describing the employee;
receive a plurality of candidate answers to another subset of the plurality of candidate questions from a job candidate; and
calculate a score of a fit of the job candidate based at least in part on the plurality of candidate answers and the performance analytics model.

2. The non-transitory computer-readable medium of claim 1, wherein the program further causes the at least one computing device to at least:
receive additional data describing another employee at the company;
receive another plurality of employee answers to another subset of the plurality of candidate questions from the other employee; and
calculating another plurality of scale scores for the other employee based at least in part on the other plurality of employee answers, the other plurality of scale scores individually corresponding to the plurality of attribute types, wherein the performance analytics model is further based at least in part on the other plurality of scale scores and the additional data describing the other employee.

3. The non-transitory computer-readable medium of claim 1, wherein the program further causes the at least one computing device to at least:
generate a first user interface comprising the subset of the plurality of candidate questions, wherein the plurality of employee answers are received via the first user interface; and
generate a second user interface comprising the other subset of the plurality of candidate questions, wherein the plurality of candidate answers are received via the second user interface.

4. The non-transitory computer-readable medium of claim 3, wherein the second user interface is a single web page application.

5. The non-transitory computer-readable medium of claim 3, wherein the score of the fit of the job candidate is calculated instantaneously in response to receiving the other plurality of employee answers to the other subset of the plurality of candidate questions from the other employee.

6. The non-transitory computer-readable medium of claim 1, wherein a plurality of question subsets of the plurality of candidate questions are individually associated to a respective attribute type of the plurality of attribute types.

7. The non-transitory computer-readable medium of claim 1, wherein the data describing the employee comprises at least one of: a length of employment, a job performance metric, or a job success metric.

8. A system, comprising:
a data store; and
at least one computing device communicably coupled to the data store, the at least one computing device configured to at least:
receive data describing a plurality of employees at a company;
receive a plurality of sets of employee answers to random selections of a plurality of candidate questions from the plurality of employees;
calculating a plurality of sets of scale scores individually corresponding to the plurality of employees based at least in part on the plurality of sets of employee answers, individual sets of the plurality of sets of scale scores corresponding to a respective one of a plurality of attribute types;
determine a plurality of preferred employee coefficients individually corresponding to the plurality of attribute types based at least in part on the plurality of sets of scale scores and the data describing the plurality of employees, the plurality of preferred employee coefficients corresponding to a job position within the company; and
identify a best fit employee from the plurality of employees based at least in part on the plurality of preferred employee coefficients and the plurality of sets of scale scores.

9. The system of claim 8, wherein the at least one computing device is further configured to at least:
calculate a plurality of predicted performance scores individually corresponding to the plurality of employees based at least in part on multiplying a respective set of the plurality of sets of scale scores to the plurality of preferred employee coefficients, wherein the a best fit employee is identified based at least in part on the plurality of predicted performance scores.

10. The system of claim 8, wherein the at least one computing device is further configured to at least store the plurality of preferred employee coefficients in the data store as a file.

11. The system of claim 8, wherein the at least one computing device is further configured to at least:
receive a request to determine training for a specific employee of the plurality of employees working in a specific job position, the specific employee corresponding to a specific set of scale scores of the plurality of sets of scale scores;
determine another plurality of preferred employee coefficients individually corresponding to the plurality of attribute types based at least in part on the plurality of sets of scale scores and the data describing the plurality of employees, the other plurality of preferred employee coefficients corresponding to the specific job position;
identify a target scale score of the specific set of scale scores based at least in part on an effect of individual ones of the specific set of scales scores on an employee fit score that represents a fit of the specific employee for the specific job position; and
assign a training program to the specific employee, the training program intended to improve the target scale score of the specific employee.

12. A method, comprising:
receiving, via at least one computing device, data describing at least one employee;
calculating, via the at least one computing device, a plurality of scale scores for the at least one employee based at least in part on a plurality of employee answers to a first plurality of candidate questions;
determining, via the at least one computing device, a preferred candidate specification based at least in part on the plurality of scale scores and the data describing the at least one employee; and
calculating, via the at least one computing device, a plurality of scores of a fit for a plurality of job candidates based at least in part on the preferred candidate specification and a plurality of sets of answers to candidate questions.

13. The method of claim 12, further comprising generating, via the at least one computing device, a candidate list user interface including a ranked list of the plurality of job candidates ranked based at least in part on the plurality of scores.

14. The method of claim 13, wherein the candidate list user interface further includes a graph detailing statistical properties of the plurality of scores of the fit for the plurality of job candidates.

15. The method of claim 13, further comprising filtering, via the at least one computing device, the ranked list of the plurality of job candidates based at least in part on at least one user selection criteria received via the candidate list user interface.

16. The method of claim 13, further comprising:
receiving, via the at least one computing device, a selection of a selected job candidate of the plurality of job candidates from the ranked list on the candidate list user interface; and
generating, via the at least one computing device, a candidate report user interface including a respective description for individual ones of a plurality of scale score types, where the plurality of scale scores individually correspond to a respective one of the plurality of scale score types.

17. The method of claim 12, wherein calculating the plurality of scores comprising executing, via the at least one computing device, at least one piece of code stored associated with the preferred candidate specification.

18. The method of claim 12, wherein the preferred candidate specification is based at least in part on past success of the at least one employee, and the plurality of scores represents a predicted future performance of a respective job candidate in a job position based at least in part on the past success.

19. The method of claim 12, further comprising receiving, via at least one computing device, data describing preferences of a company, wherein the plurality of scores of the fit for the plurality of job candidates is further based at least in part on the data describing the preferences of the company.

20. The method of claim 19, wherein the data describing the preferences of the company comprises a preference for employee retention.
